(19) United States
(12) Patent Application Publication
(10) Pub. No.: US 2026/0025179 A1
(43) Pub. Date: Jan. 22, 2026

(54) CHANNEL STATE INFORMATION REFERENCE SIGNALS FOR COHERENT JOINT TRANSMISSION IN MULTIPLE TRANSMIT RECEIVE POINT DEPLOYMENTS

(71) Applicant: QUALCOMM INCORPORATED, San Diego, CA (US)

(72) Inventors: Tianyang BAI, Mountain View, CA (US); Yan ZHOU, San Diego, CA (US); Fang YUAN, Beijing (CN); Junyi LI, Greentown, PA (US); Tao LUO, San Diego, CA (US)

(21) Appl. No.: 18/875,713

(22) PCT Filed: Aug. 26, 2022
(86) PCT No.: PCT/CN2022/115042

§ 371 Date: Dec. 16, 2024

(51) Int. Cl. H04B 7/06; H04B 7/024

(52) U.S. Cl. CPC H04B 7/0626; H04B 7/024; H04B 7/0632; H04B 7/06968

(57) ABSTRACT

Various aspects of the present disclosure generally relate to wireless communication. In some aspects, a user equipment (UE) may receive, for coherent joint transmission (CJT) communication with a plurality of transmit receive points (TRPs), a channel state information (CSI) report configuration for a CSI report associated with a plurality of TCI states, wherein the CSI report configuration indicates one or more CSI reference signal (CSI-RS) resources. The UE may receive a CSI-RS transmission in the one or more CSI-RS resources using a TCI state of the plurality of TCI states. Numerous other aspects are described.

### FIELD OF THE DISCLOSURE

Aspects of the present disclosure generally relate to wireless communication and to techniques and apparatuses for channel state information reference signals for coherent joint transmission in multiple transmit receive point deployments.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a user equipment (UE). The method may include receiving, for coherent joint transmission (CJT) communication with a plurality of transmit receive points (TRPs), a channel state information (CSI) report configuration for a CSI report associated with a plurality of transmission configuration indicator (TCI) states, wherein the CSI report configuration indicates one or more CSI reference signal (CSI-RS) resources. The method may include receiving a CSI-RS transmission in the one or more CSI-RS resources using a TCI state of the plurality of TCI states.

Some aspects described herein relate to a method of wireless communication performed by a network node. The method may include transmitting, for CJT communication with a plurality of TRPs, a CSI report configuration for a CSI report associated with a plurality of TCI states, wherein the CSI report configuration indicates one or more CSI-RS resources. The method may include transmitting a CSI-RS transmission in the one or more CSI-RS resources using a TCI state of the plurality of TCI states.

Some aspects described herein relate to a UE for wireless communication. The UE may include a memory and one or more processors coupled to the memory. The one or more processors may be configured to receive, for CJT communication with a plurality of TRPs, a CSI report configuration for a CSI report associated with a plurality of TCI states, wherein the CSI report configuration indicates one or more CSI-RS resources. The one or more processors may be configured to receive a CSI-RS transmission in the one or more CSI-RS resources using a TCI state of the plurality of TC states.

Some aspects described herein relate to a network node for wireless communication. The network node may include a memory and one or more processors coupled to the memory. The one or more processors may be configured to transmit, for CJT communication with a plurality of TRPs, a CSI report configuration for a CSI report associated with a plurality of TCI states, wherein the CSI report configuration indicates one or more CSI-RS resources. The one or more processors may be configured to transmit a CSI-RS transmission in the one or more CSI-RS resources using a TCI state of the plurality of TCI states.

Some aspects described herein relate to a non-transitory computer-readable medium that stores a set of instructions for wireless communication by a one or more instructions that, when executed by one or more processors of a UE. The set of instructions, when executed by one or more processors of the UE, may cause the one or more one processors of the UE to receive, for CJT communication with a plurality of TRPs, a CSI report configuration for a CSI report associated with a plurality of TCI states, wherein the CSI report configuration indicates one or more CSI-RS resources. The set of instructions, when executed by the one or more processors of the UE, may cause the one or more processors of the UE to receive a CSI-RS transmission in the one or more CSI-RS resources using a TCI state of the plurality of TCI states.

Some aspects described herein relate to a non-transitory computer-readable medium that stores a set of instructions for wireless communication by a network node. The set of instructions, when executed by one or more processors of the network node, may cause the network node to transmit, for CJT communication with a plurality of TRPs, a CSI report configuration for a CSI report associated with a plurality of TCI states, wherein the CSI report configuration indicates one or more CSI-RS resources. The set of instructions, when executed by one or more processors of the network node, may cause the network node to transmit a CSI-RS transmission in the one or more CSI-RS resources using a TCI state of the plurality of TCI states.

Some aspects described herein relate to an apparatus for wireless communication. The apparatus may include means for receiving, for CJT communication with a plurality of TRPs, a CSI report configuration for a CSI report associated with a plurality of TCI states, wherein the CSI report configuration indicates one or more CSI-RS resources. The apparatus may include means for receiving a CSI-RS transmission in the one or more CSI-RS resources using a TCI state of the plurality of TCI states.

Some aspects described herein relate to an apparatus for wireless communication. The apparatus may include means for transmitting, for CJT communication with a plurality of TRPs, a CSI report configuration for a CSI report associated with a plurality of TCI states, wherein the CSI report configuration indicates one or more CSI-RS resources. The apparatus may include means for transmitting a CSI-RS transmission in the one or more CSI-RS resources using a TCI state of the plurality of TCI states.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example logical architecture of a distributed radio access network (RAN), in accordance with the present disclosure.

FIG. 5 is a diagram illustrating an example of multiple transmit receive point (mTRP, multi-TRP, or multi-panel) communication, in accordance with the present disclosure.

FIG. 6 is a diagram illustrating an example of physical channels and reference signals in a wireless network, in accordance with the present disclosure.

FIG. 7 is a diagram illustrating an example of using beams for communications between a network node and a UE, in accordance with the present disclosure.

FIG. 8 is a diagram illustrating an example of coherence in transmissions across multiple TRPs, in accordance with the present disclosure.

FIG. 9 is a diagram illustrating an example associated with using CSI-RSs for CJT in mTRP deployments, in accordance with the present disclosure.

FIG. 10 is a diagram illustrating an example associated with using CSI-RSs for CT in mTRP deployments, in accordance with the present disclosure.

FIG. 11 is a diagram illustrating an example process performed, for example, by an apparatus, in accordance with the present disclosure.

FIG. 12 is a diagram illustrating an example process performed, for example, by a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

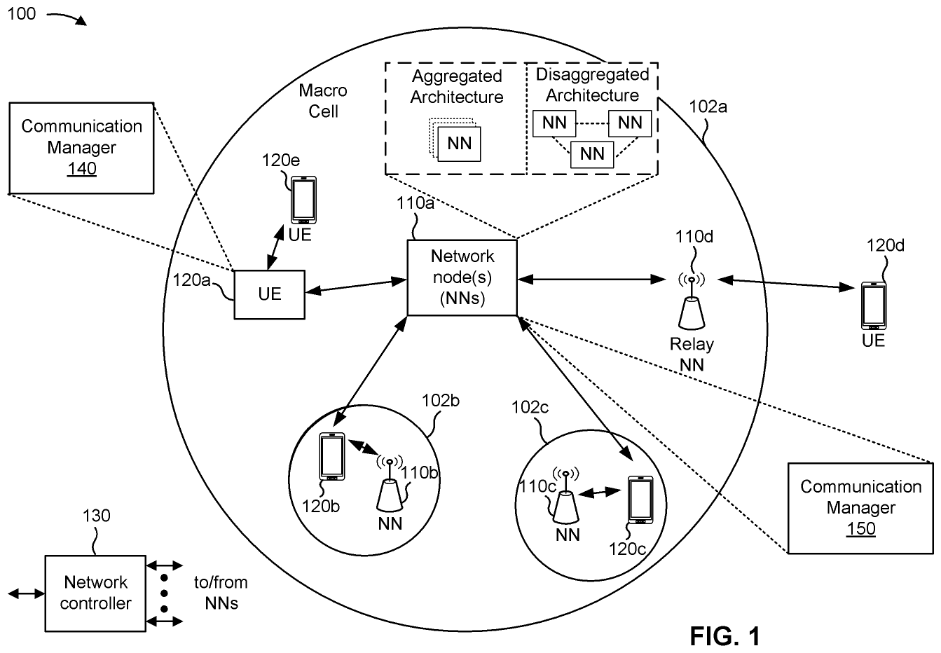

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components.

In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, for coherent joint transmission (CJT) communication with a plurality of transmit receive points (TRPs), a channel state information (CSI) report configuration for a CSI report associated with a plurality of transmission configuration indicator (TCI) states, wherein the CSI report configuration indicates one or more CSI reference signal (CSI-RS) resources; and receive a CSI-RS transmission in the one or more CSI-RS resources using a TCI state of the plurality of TCI states. Additionally, or alternatively, the communication manager 140 may perform one or more other operations described herein.

In some aspects, the network node 110 may include a communication manager 150. As described in more detail elsewhere herein, the communication manager 150 may transmit, for CJT communication with a plurality of TRPs, a CSI report configuration for a CSI report associated with a plurality of TCI states, wherein the CSI report configuration indicates one or more CSI-RS resources; and transmit a CSI-RS transmission in the one or more CSI-RS resources using a TCI state of the plurality of TCI states. Additionally, or alternatively, the communication manager 150 may perform one or more other operations described herein.

As indicated above, FIG. 1 is provided as an example. Other examples may differ from what is described with regard to FIG. 1.

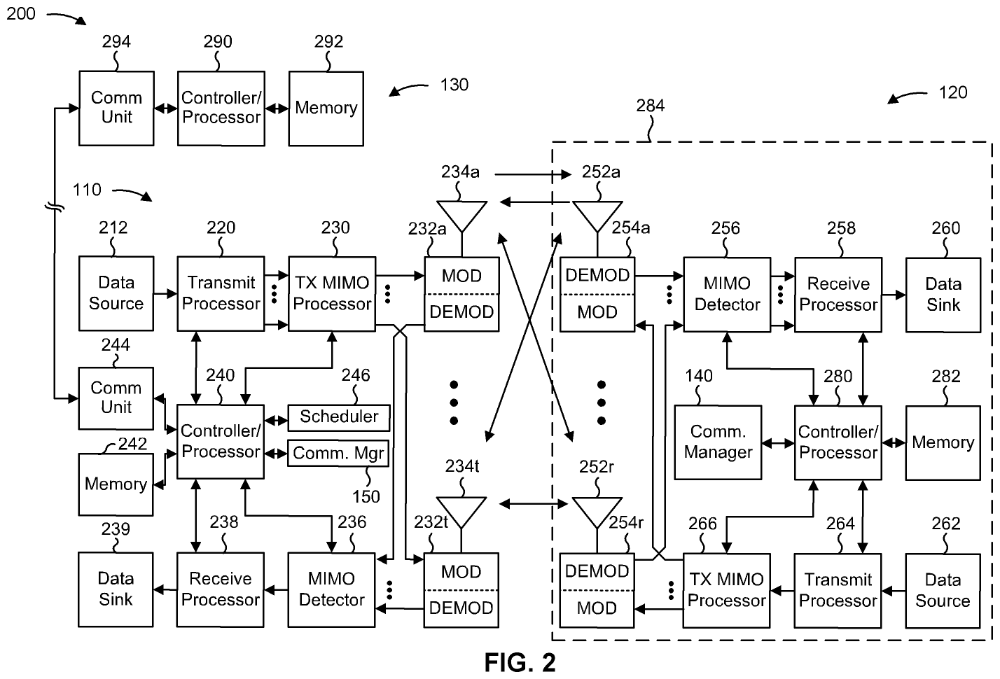

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

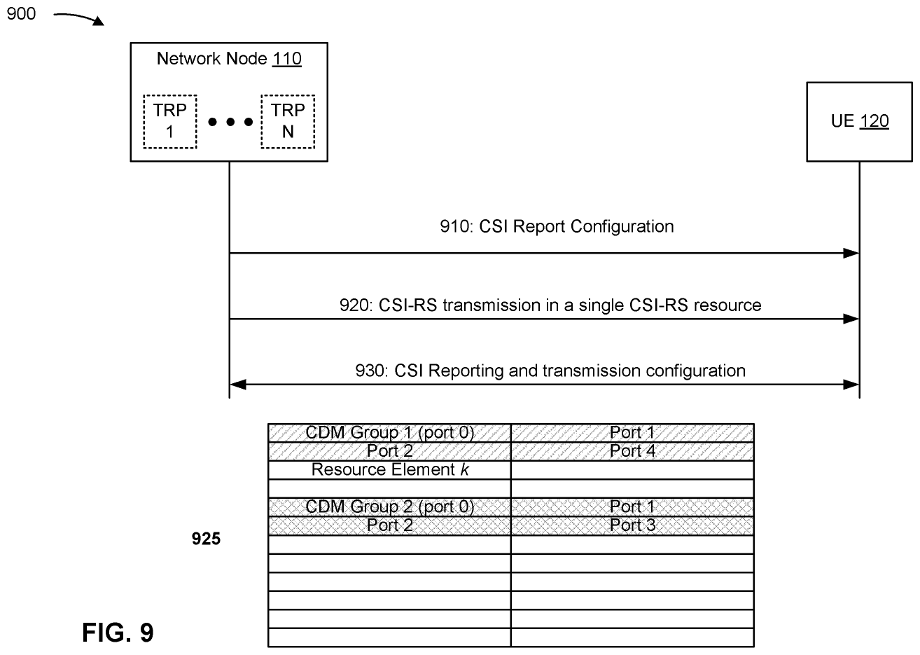

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 9-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 9-14).

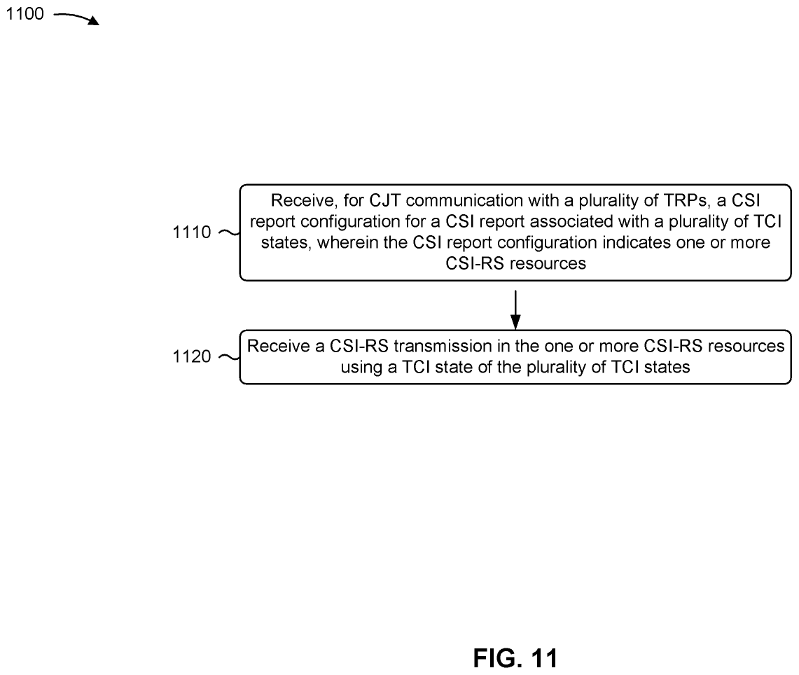

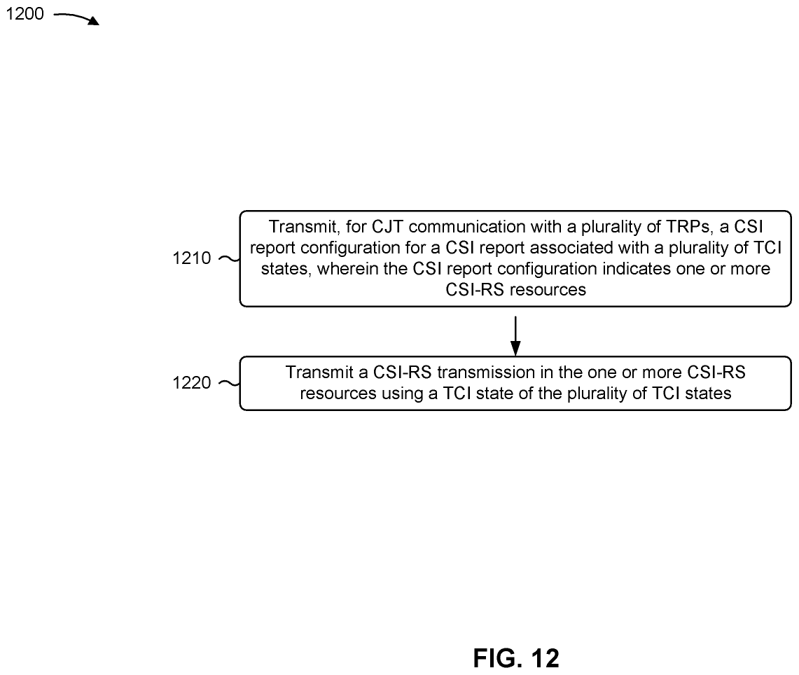

The controller/processor 240 of the network node 110, the controller/processor 280 of the UE 120, and/or any other component(s) of FIG. 2 may perform one or more techniques associated with CSI-RSs for CJT in multiple TRP (mTRP or multi-TRP) deployments, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively.

In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for receiving, for CJT communication with a plurality of TRPs, a CSI report configuration for a CSI report associated with a plurality of TCI states, wherein the CSI report configuration indicates one or more CSI-RS resources; and/or means for receiving a CSI-RS transmission in the one or more CSI-RS resources using a TCI state of the plurality of TCI states. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, for CJT communication with a plurality of TRPs, a CSI report configuration for a CSI report associated with a plurality of TCI states, wherein the CSI report configuration indicates one or more CSI reference signal (CSI-RS) resources; and/or means for transmitting a CSI-RS transmission in the one or more CSI-RS resources using a TCI state of the plurality of TCI states. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

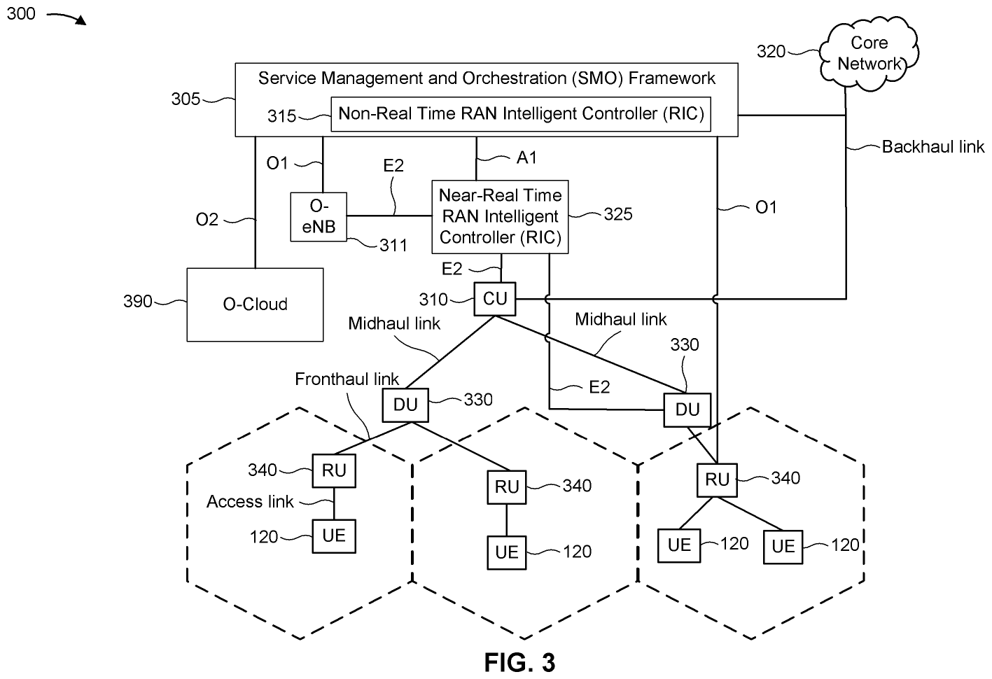

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture. Each CU 310, DU 330, or RU 340, among other examples, may correspond to a TRP or network node described elsewhere herein.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

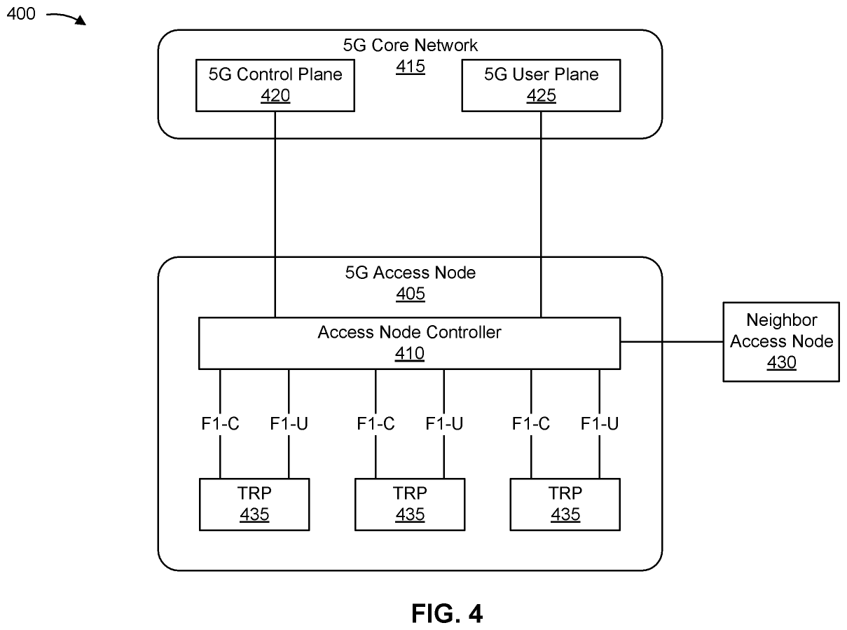

FIG. 4 illustrates an example logical architecture of a distributed RAN 400, in accordance with the present disclosure.

A 5G access node 405 may include an access node controller 410. The access node controller 410 may be a CU of the distributed RAN 400 and may correspond to the CU 310 of FIG. 3. In some examples, the access node controller 410 may correspond to the network node 110 of FIG. 1. In some examples, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may include a DU and/or an RU of the distributed RAN 400 and may correspond to the DU 330 and/or the RU 340 of FIG. 3. In some examples, a TRP 435 may correspond to a network node 110 described above in connection with FIG. 1. For example, different TRPs 435 may be included in different network nodes 110. Additionally, or alternatively, multiple TRPs 435 may be included in a single network node 110. In some examples, a network node 110 may include a CU (e.g., access node controller 410) and/or one or more DUs (e.g., one or more TRPs 435). In some cases, a TRP 435 may be referred to as a cell, a panel, an antenna array, or an army.

A TRP 435 may be connected to a single access node controller 410 or to multiple access node controllers 410. In some examples, a dynamic configuration of split logical functions may be present within the architecture of distributed RAN 400, referred to elsewhere herein as a functional split. For example, a packet data convergence protocol (PDCP) layer, a radio link control (RLC) layer, and/or a medium access control (MAC) layer may be configured to terminate at the access node controller 410 or at a TRP 435.

In some examples, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some examples, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

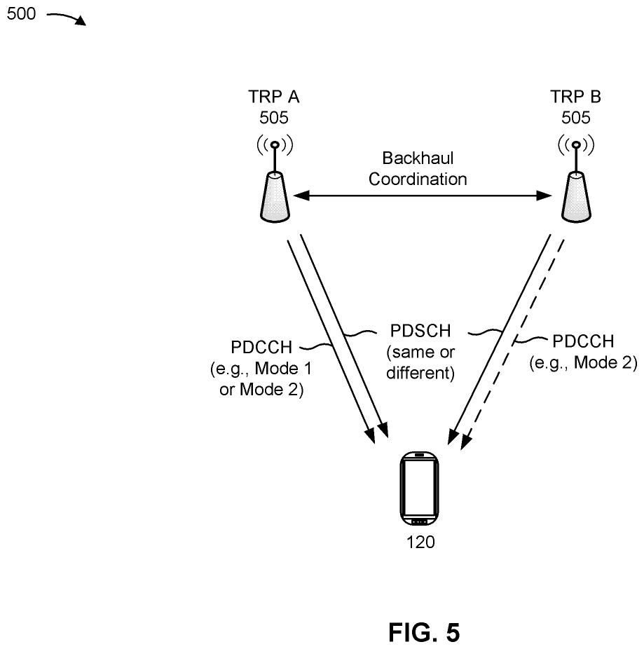

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110), and may have a larger delay and/or lower capacity (as compared to co-location) when the TRPs 505 are located at different network nodes 110. The different TRPs 505 may communicate with the UE 120 using different QCL relationships (e.g., different TCI states), different demodulation reference signal (DMRS) ports, and/or different layers (e.g., of a multi-layer communication).

Although example 500 shows an example of two TRPs 505, other quantities of TRPs are contemplated. For example, it has been proposed in 3GPP Release 18 (R18) that, in FR1, up to 4 TRPs may be deployed for CJT.

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a fust TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state). A unified TCI framework has been proposed, in 3GPP Release 17 (R17) for indication of downlink (DL) and uplink (UL) TCI states, such as for multi-TRP deployments. The unified TCI framework may include Type-1 TCI (e.g., a joint TCI state to indicate a common beam for at least one DL channel or RS and at least one UL channel or RS), Type-2 TCI (e.g., a separate DL TCI state to indicate a common beam for a plurality of DL channels or RSs), and Type-3 TCI (e.g., a separate UL TCI state to indicate a common beam for a plurality of UL channels or RSs). Other TCI states may be possible for the unified TCI framework and are contemplated.

In some examples, the UE 120 may receive a DCI or a MAC-CE (e.g., associated with a DCI format 11 or 1_2) that indicates a switch from a first TCI state to a second TCI state. The UE 120 may transmit an acknowledgement (ACK), as a response to the reception of the DCI or the MAC-CE, in a PUCCH and/or a PUSCH. The UE 120 may switch from the first TCI state to the second TCI state based at least in part on receiving the DCI or the MAC-CE and/or based at least in part on transmitting the ACK in the PUSCH and/or the PUCCH. A time duration between the transmitting the ACK and switching to the second TCI state may be based at least in part on a beam application time (BAT). In some aspects, the switching from the first TCI state to the second TCI state includes switching from the first TCI state to the second TCI state for all configured bandwidth parts in one or more component carriers. In some aspects, the BAT may be based at least in part on a beam switching time of the UE (e.g., a UE capability). In some aspects, the BAT may be configured based at least in part on a smallest subcarrier spacing of the one or more component carriers.

In some aspects, a timing for the switching from the first TCI state to the second TCI state is based at least in part on a BAT associated with at least one active bandwidth part (BWP) of the one or more component carriers. In some aspects, a first slot in which to apply the second TCI state and the duration of the BAT may be determined based at least in part on an active BWP with a smallest subcarrier spacing among a set of active BWPs associated with the one or more of component carriers. In this case, the selected active BWP of the one or more of component carriers may be determined based at least in part on a configuration at a time when the UE 120 receives the DCI or the MAC-CE that indicates the TCI switch. Alternatively, the active BWP of the one or more of component carriers may be determined based at least in part on a configuration at a time when the UE 120 transmits the ACK, as a response to the DCI or the MAC-CE, that indicates the TCI switch. Alternatively, the active BWP of the one or more component carriers may be determined based at least in part on a configuration at a time when the UE 120 receives a PDSCH or a CSI-RS that is scheduled by a DCI, which indicates the TCI switch. In some aspects, the aforementioned one or more component carriers may be a plurality of component carriers.

As indicated above, FIG. 5 is provided as an example. Other examples may differ from what is described with respect to FIG. 5.

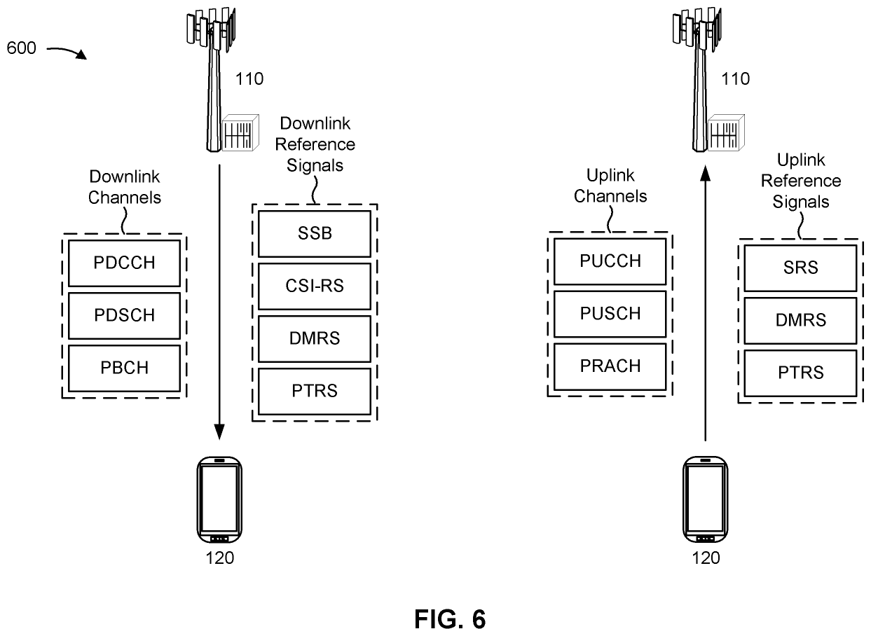

FIG. 6 is a diagram illustrating an example 600 of physical channels and reference signals in a wireless network, in accordance with the present disclosure. As shown in FIG. 6, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (RS) (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

A radio link failure (RLF) reference signal (RS) may carry information to indicate and/or enable recovery from a radio link failure. For example, the UE 120 may monitor for an RLF RS to monitor for a radio link failure (e.g., by comparing a measured reference signal received power (RSRP) with a threshold value and determining that a radio link failure has occurred when the RSRP is less than the threshold value). When an RLF RS is not configured for the UE 120 (e.g., in radio resource control (RRC) signaling) the UE 120 may identify another reference signal as the RLF RS. For example, the UE 120 may select a reference signal based at least in part on a TCI state of a received PDCCH. In 3GPP Release 17 (R17), a serving cell TCI may be associated with a non-serving cell reference signal. In this case, a QCL parameter of a TCI in the serving cell may be based at least in part on an SSB of the non-serving cell. However, the non-serving cell related TCI may not be used to select an RLF RS for the serving cell to avoid a failure to properly detect a radio link failure.

In some aspects, when the UE 120 is not provided with information identifying an RLF RS (e.g., a parameter RadioLinkMonitoringRS) and the UE is provided with TCI states (e.g., from PDCCH reception) associated with a serving cell physical layer cell identifier (PCI) that includes one or more CSI-RS resources, the UE 120 may select, for radio link monitoring, an RS provided for an active TCI state associated with the serving cell PCI for PDCCH reception (e.g., if the active TCI state associated with the serving cell PCI for PDCCH reception includes a single RS). In contrast, when the active TCI state associated with the serving cell PCI for PDCCH reception includes a plurality (e.g., two) RSs, the UE 120 may select an RS that has a QCL type set to Type-D. In this case, the network node 110 may be configured to set only a single RS, of the plurality of RSs, with QCL Type-D, thereby enabling the UE 120 to deterministically select an RS for radio link monitoring (e.g., for radio link failure). In some aspects, the UE 120 may select a periodic reference signal (e.g., and may discard, from selection, aperiodic or semi-persistent reference signals). In some aspects, when a quantity of control resource sets (CORESETs) is larger than a maximum quantity of RLF RSs that the UE 120 can support, the UE 120 may select an RS provided for active TCI states associated with a serving cell PCI for PDCCH receptions in CORESETs associated with search space sets in an order from the shortest monitoring periodicity. If multiple CORESETs are associated with search space sets having the same monitoring peridocity, the UE 120 may further determine the aforementioned order of CORESETs based at least in part on CORESET index values (e.g., from highest CORESET index value to lowest CORESET index value).

For beam failure recovery, the UE 120 may be configured with a first dedicated resource (e.g., a parameter schedulingRequestID-BFR-Scell) on which to transmit a beam failure recovery request for a secondary cell (SCell) beam failure recovery (BFR) or a per-TRP BFR. The network node 110 may further configure a second dedicated resource (e.g., a scheduling request resource) using a parameter (schedulingRequestD-BFR2) for per-TRP BFR based at least in part on the UE 120 reporting a capability (twoLRRcapability) for being configured with 2 PUCCH scheduling request (SR) resources for per-TRP BFR. In this case, each PUCCH SR resource may be used to report beam failure associated with a particular TRP. Accordingly, the UE 120 can be configured by a SchedulingRequestResourceConfig parameter with a set of configurations for SR in a PUCCH transmission using PUCCH format 0 or PUCCH format 1. Similarly, the UE 120 can be configured by a schedulingRequestID-BFR-SCell parameter with a configuration for link recovery request (LRR) in a PUCCH transmission using PUCCH format 0 or PUCCH format 1 (e.g., the LRR can be used as a BFR for an SCell or a TRP). Accordingly, the UE 120 may be configured by a schedulingRequestID-BFR parameter with a first configuration for LRR and, if the UE 120 provides the twoLRRcapability parameter, the UE 120 can be configured by a schedulingRequestID-BFR2 parameter with a second configuration for LRR in a PUCCH transmission using either PUCCH format 0 or PUCCH format 1.

As indicated above, FIG. 6 is provided as an example. Other examples may differ from what is described with regard to FIG. 6.

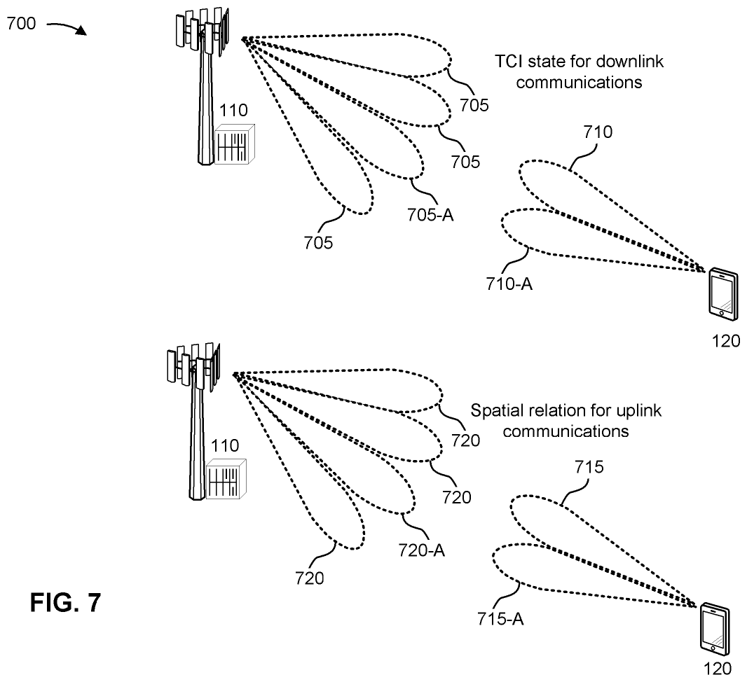

FIG. 7 is a diagram illustrating an example 700 of using beams for communications between a network node and a UE, in accordance with the present disclosure. As shown in FIG. 7, a network node 110 and a UE 120 may communicate with one another.

The network node 110 may transmit to UEs 120 located within a coverage area of the network node 110. The network node 110 and the UE 120 may be configured for beamformed communications, where the network node 110 may transmit in the direction of the UE 120 using a directional network node (NN) transmit beam (e.g., a BS transmit beam), and the UE 120 may receive the transmission using a directional UE receive beam. Each NN transmit beam may have an associated beam ID, beam direction, or beam symbols, among other examples. The network node 110 may transmit downlink communications via one or more NN transmit beams 705.

The UE 120 may attempt to receive downlink transmissions via one or more UE receive beams 710, which may be configured using different beamforming parameters at receive circuitry of the UE 120. The UE 120 may identify a particular NN transmit beam 705, shown as NN transmit beam 705-A, and a particular UE receive beam 710, shown as UE receive beam 710-A, that provide relatively favorable performance (for example, that have a best channel quality of the different measured combinations of NN transmit beams 705 and UE receive beams 710). In some examples, the UE 120 may transmit an indication of which NN transmit beam 705 is identified by the UE 120 as a preferred NN transmit beam, which the network node 110 may select for transmissions to the UE 120. The UE 120 may thus attain and maintain a beam pair link (BPL) with the network node 110 for downlink communications (for example, a combination of the NN transmit beam 705-A and the UE receive beam 710-A), which may be further refined and maintained in accordance with one or more established beam refinement procedures.

A downlink beam, such as an NN transmit beam 705 or a UE receive beam 710, may be associated with a TCI state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each NN transmit beam 705 may be associated with a SSB, and the UE 120 may indicate a preferred NN transmit beam 705 by transmitting uplink transmissions in resources of the SSB that are associated with the preferred NN transmit beam 705. A particular SSB may have an associated TCI state (for example, for an antenna port or for beamforming). The network node 110 may, in some examples, indicate a downlink NN transmit beam 705 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 710 at the UE 120. Thus, the UE 120 may select a corresponding UE receive beam 710 from a set of BPLs based at least in part on the network node 110 indicating an NN transmit beam 705 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a PDSCH. The set of activated TCI states for downlink control channel communications may correspond to beams that the network node 110 may use for downlink transmission on a PDCCH or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the network node 110 using a directional UE transmit beam, and the network node 110 may receive the transmission using a directional NN receive beam. Each UE transmit beam may have an associated beam ID, beam direction, or beam symbols, among other examples. The UE 120 may transmit uplink communications via one or more UE transmit beams 715.

The network node 110 may receive uplink transmissions via one or more NN receive beams 720 (e.g., BS receive beams). The network node 110 may identify a particular UE transmit beam 715, shown as UE transmit beam 715-A, and a particular NN receive beam 720, shown as NN receive beam 720-A, that provide relatively favorable performance (for example, that have a best channel quality of the different measured combinations of UE transmit beams 715 and NN receive beams 720). In some examples, the network node 110 may transmit an indication of which UE transmit beam 715 is identified by the network node 110 as a preferred UE transmit beam, which the network node 110 may select for transmissions from the UE 120. The UE 120 and the network node 110 may thus attain and maintain a BPL for uplink communications (for example, a combination of the UE transmit beam 715-A and the NN receive beam 720-A), which may be further refined and maintained in accordance with one or more established beam refinement procedures. An uplink beam, such as a UE transmit beam 715 or an NN receive beam 720, may be associated with a spatial relation. A spatial relation may indicate a directionality or a characteristic of the uplink beam, similar to one or more QCL properties, as described above.

The antennas of a multi-antenna wireless communication device such as a UE (e.g., UE 120) may be classified into one of three groups (e.g., coherent, non-coherent, or partially coherent) depending on coherence of the antenna ports of the UE. A set of antenna ports (for example, two antenna ports) are coherent if the relative phase among the set of antenna ports (for example, between the two antenna ports) remains the same between the time of an SRS transmission from those antenna ports and a subsequent PUSCH transmission from those antenna ports. In this case, the SRS may be used (for example, by the UE or a network node) to determine an uplink precoder for precoding the PUSCH transmission, because the relative phase of the antenna ports will be the same for the SRS transmission and the PUSCH transmission. The precoding may span across the set of coherent antenna ports.

As indicated above, FIG. 7 is provided as an example. Other examples may differ from what is described with respect to FIG. 7.

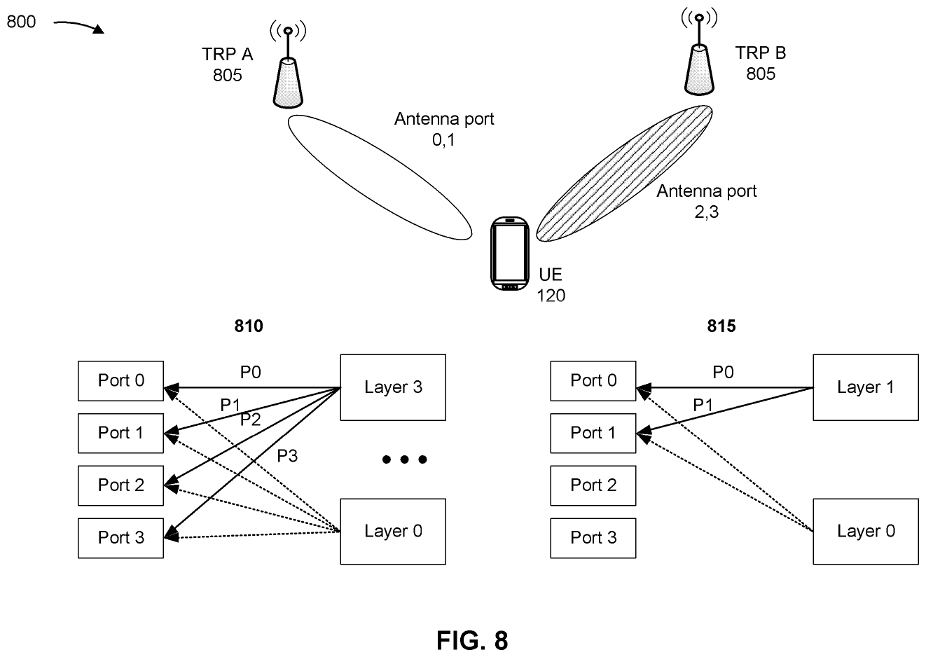

FIG. 8 is a diagram illustrating an example 800 of coherence in transmissions across multiple TRPs, in accordance with the present disclosure. As shown in FIG. 8, example 800 includes a first TRP A 805, a second TRP B 805, and a UE 120. TRPs A and B may correspond to network nodes 110, components of the disaggregated base station of FIG. 2, TRPs 435, or TRPs 505, among other examples.

In some examples, phase coherence may be present for CJT across a plurality of TRPs 805. Accordingly, precoding may be applied across the plurality of TRPs 805. In contrast, for non-coherent joint transmission (NCJT), precoding is only applied within each TRP, resulting in different TRPs transmitting different precoded layers. As shown in FIG. 8, for CJT, there may be 4 layers across 2 TRPs 805, with each TRP 805 having 2 ports corresponding to 2 polarizations of the same TCI state (e.g., 2 polarizations of the same beamforming directions). In this case, for CJT, 4 layers of data can be precoded by a 4×4 matrix and, after precoding, respective outputs of each antenna port of the 2 TRPs 805 includes a contribution from all 4 layers, as shown by diagram 810. In contrast, for NCJT, layers 0 and 1 are precoded by a first 2×2 matrix and transmitted via ports of TRP A 805 and layers 2 and 3 are precoded by a second 2×2 matrix and transmitted via ports of TRP B 805. In this case, an output of TRP A 805 includes information only from layers 0 and 1, as shown by diagram 815, and an output of TRP B 805 includes information only from layers 2 and 3.

As indicated above, FIG. 8 is provided as an example. Other examples may differ from what is described with respect to FIG. 8.

A network node may transmit CSI-RS resources (CSI-RS transmissions in resources allocated for CSI-RSs) via different antenna ports of different TRPs to enable a determination of a best precoder for use in multi-layer transmission. A UE may measure the CSI-RS resources, determine CSI feedback (e.g., a precoding matrix indicator (PMI), a rank indicator (RI), or a channel quality indicator (CQI)), and transmit a CSI report to the network node. The network node may use the CSI report to select the best precoder (e.g., a precoder that achieves a highest level of communication performance, such as achieving a lowest predicted likelihood of dropped or non-decodable communications). In CJT communication in mTRP deployments, antenna ports are from different TRPs and are received using different RS beams. Accordingly, CSI-RS reception from different ports of different TRPs can be associated with different TCIs. However, the network node may only be configured to transmit a single TCI to configure a CSI-RS resource for different antenna ports, rather than configuring CSI-RS resources for a CSI report associated with different TCIs.

Furthermore, for a CSI acquisition report, each CSI report can be configured with a single CSI-RS resource for channel measurement. A CSI report can be configured with additional CSI-RSs for zero-phase (ZP) or non-zero-phase (NZP) interference measurement, but not for channel measurement of MIMO channels. In this case, each CSI-RS resource is configured for a single TCI. However, in CJT communication in mTRP deployments, configuring a plurality of CSI reports with a plurality of CSI-RS resources for channel measurement associated with different TCIs and TRPs may be an inefficient use of network resources (e.g., causing excessive overhead, network utilization, and/or signaling).

Some aspects described herein enable a single CSI-RS resource to be configured with a plurality of TCI states corresponding to a plurality of different ports of a plurality of different TRPs in a CJT mTRP deployment. Additionally, or alternatively, some aspects may enable a CSI report configuration for CJT channel acquisition to be associated with a plurality of CSI-RS resources (corresponding to a plurality of different TCI states and/or TRPs) for channel measurement. In this way, a network node and a UE reduce an amount of overhead, network utilization, and/or signaling by reducing duplicative CSI reporting and enabling selection of a precoder for CJT mTRP deployments.

FIG. 9 is a diagram illustrating an example 900 associated with using CSI-RSs for CJT in mTRP deployments, in accordance with the present disclosure. As shown in FIG. 9, example 900 includes communication between a network node 110 and a UE 120.

As further shown in FIG. 9, and by reference number 910, the UE 120 may receive a CSI report configuration from the network node 110. For example, the network node 110 may transmit CSI report configuration information identifying a CSI report configuration for the UE 120. In some aspects, the network node 110 may configure a TCI of a CSI-RS resource and/or activate a TCI of a CSI-RS resource. For example, the network node 110 may transmit first signaling to configure a plurality of TCIs (corresponding to a plurality of TCI states) for a single CSI-RS resource. In some aspects, the network node 110 may transmit the first signaling to convey a TCI codepoint that identifies or corresponds to the plurality of TCIs. In some aspects, the network node 110 may transmit second signaling (e.g., a medium access control (MAC) control element (CE)) to activate one or more of the plurality of TCIs. In some aspects, the MAC CE may be configured to include information elements (IEs) for conveying activation of a plurality of TCIs for a single CSI-RS resource.

As further shown in FIG. 9, and by reference number 920, the UE 120 may receive a CSI-RS transmission in a single CSI-RS resource. For example, the UE 120 may receive a CSI-RS from a port of a TRP associated with the network node 110. In some aspects, the UE 120 may receive the CSI-RS based at least in a mapping between TCI states and ports. For example, the UE 120 may have mapping information identifying a TCI-state-to-port mapping of which ports correspond to which TCIs and/or TRPs. In some aspects, the UE 120 may have port group information. For example, a set of port groups may be associated with a set of TCIs and each port group may have a plurality of ports associated with a corresponding TCI. In this case, the UE 120 may receive a CSI-RS using a port and associated TCI based at least in part on a port-group-to-TCI-state mapping.

In some aspects, the UE 120 may receive signaling indicating an association or other mapping between a TC and a port. For example, the network node 110 may transmit a MAC CE to activate TCIs for a CSI-RS resource, and the MAC CE may include information indicating an association between the activated TCIs and one or more ports. In this case, the information indicating the association may be a bitmap or other field. Additionally, or alternatively, the UE 120 may receive radio resource control (RRC) signaling identifying a set of possible mappings and may receive downlink control information (DCI) or MAC CE signaling selecting one mapping of the set of possible mappings as a mapping to use for receiving a particular CSI-RS.

In some aspects, the UE 120 may determine the association between a TCI and a port based at least in part on a static rule. As a first example, for a set of M ports and N TCs, the UE 120 may be configured to map TCIs to ports sequentially by port identifiers. In this case, each consecutive set of MIN ports may be associated to a common port group and linked to a common TCI. In other words, for ports 0 to 3 and TCIs 0 to 1, ports 0 and 1 form a first port group and link to TC 0, and ports 2 and 3 form a second port group and link to TCI 1. As a second example, ports of a common code division multiplexing (CDM) group may be associated with a common TCI or TRP, and a mapping of CDM groups to TCIs may be based at least in part on an order of CDM group identifiers and TCI or TRP identifiers. In other words, ports of a first CDM group map to a first TCI and TRP and ports of a second CDM group map to a second TCI and TRP. In this case, the UE 120 may receive information identifying a mapping between ports and CDM groups via RRC signaling (e.g., in a CSI-RS configuration message, such as a CSI-RS report configuration or other configuration information). Further to the second example, as shown by diagram 925, a CDM group may include a subset of resource elements (REs) configured for a CSI-RS resource and may correspond to a plurality of antenna ports. In this case, different antenna ports of the same CDM group may share CSI-RS REs, but may have orthogonal scrambling codes to enable the UE 120 to distinguish between received signals from different ports within the same CDM group.

In some aspects, one or more restrictions may be present on port associations. Based at least in part on reference signals from different TCIs or TRPs having different receive timings or frequency offsets, received CSI-RS signals from different TRPs or TCIs may not maintain orthogonality of the orthogonal cover code (OCC) if they are configured in the same CDM group. As a result, channel estimation may be inaccurate as a result of leakage between different signals (e.g., when orthogonality of OCC is not maintained). Accordingly, the network node 110 may not configure different ports from different TCIs or TRPs in the same CDM group. In other words, a first CDM group may have ports associated with a first TCI or TRP and a second CDM group may have ports associated with a second TCI or TRP, but the first CDM group may not have ports associated with the second TCI or TRP and the second CDM group may not have ports associated with the first TCI or TRP. As another example of a restriction, a receive timing difference (or offset) for signals from different TRPs or TCIs may be configured to be smaller than a configured threshold. For example, the network node 110 may set a threshold as less than a cyclic prefix value and may schedule receive timings for different TRPs or TCIs with an offset less than the threshold. In some aspects, the network node 110 may determine the receive timing difference (and adjust scheduling) based at least in part on UE feedback received from the UE 120.

As further shown in FIG. 9, and by reference number 930, the UE 120 may transmit CSI reporting and/or may receive a transmission configuration. For example, the UE 120 may transmit CSI reporting to the network node 110, the network node 110 may determine a transmission configuration for communication, and/or the network node 110 may transmit information identifying the transmission configuration to the UE 120 to enable subsequent communication between the network node 110 and the UE 120. In some aspects, the transmission configuration may include precoding information associated with receiving information from and/or transmitting information to the set of TRPs associated with the network node 110.

As indicated above, FIG. 9 is provided as an example. Other examples may differ from what is described with respect to FIG. 9.

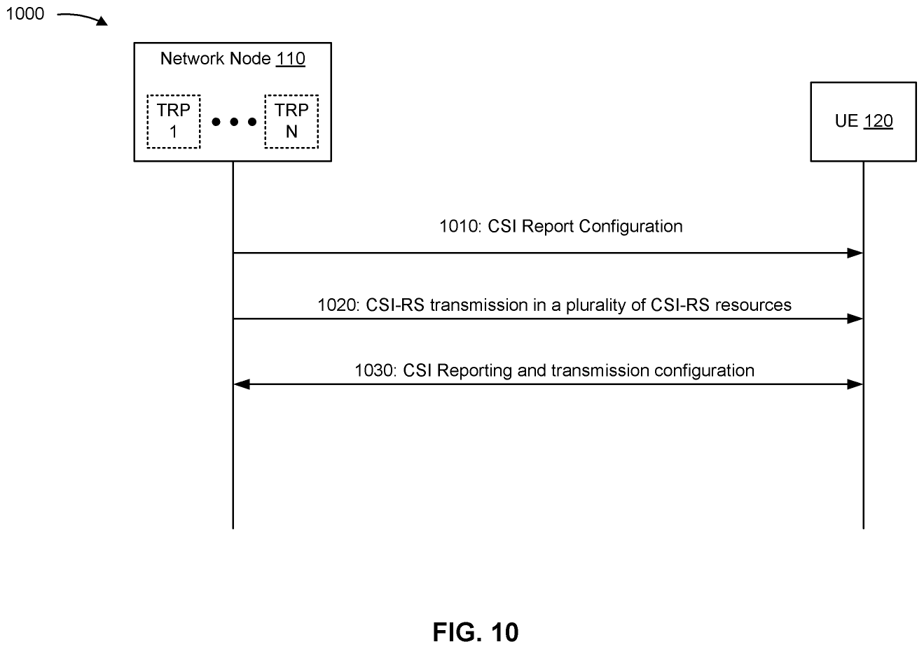

FIG. 10 is a diagram illustrating an example 1000 associated with using CSI-RSs for CJT in mTRP deployments, in accordance with the present disclosure. As shown in FIG. 10, example 1000 includes communication between a network node 110 (e.g., which includes or is associated with a set of TRPs) and a UE 120.

As further shown in FIG. 10, and by reference number 1010, the UE 120 may receive a CSI report configuration from the network node 110. For example, the network node 110 may transmit CSI report configuration information identifying a CSI report configuration for the UE 120. In some aspects, the network node 110 may configure a TCI of a CSI-RS resource and/or activate a TCI of a CSI-RS resource, as described above. In some aspects, the CSI report configuration may be associated with a plurality of CSI-RS resources for channel measurement. For example, when the UE 120 receives a CSI report configuration for CJT channel acquisition, the UE 120 may interpret the CSI report configuration to identify a plurality of CSI-RS resources associated with a plurality of TCIs (TCI states) and TRPs. In this case, the UE 120 may identify a first CSI-RS resource associated with a first TCI and a first TRP and a second CSI-RS resource associated with a second TCI and a second TRP. Additional numbers of CSI-RS resources, TCIs, and TRPs are contemplated.

In some aspects, the CSI report configuration may be associated with CSI acquisition. For example, the CSI report configuration may include information associated with configuring the UE 120 to report a PMI value, an RI value, or a CQI value, among other examples. In this case, the UE 120 may derive the PMI value, the RI value, or the CQI value, among other examples for CJT across a plurality of TRPs based at least in part on receiving different groups of CSI-RS resources from the plurality of TRPs. In some aspects, the CSI report configuration may have grouped CSI-RS resources. For example, the UE 120 may receive RRC or MAC CE signaling identifying a set of group identifiers corresponding to different sets of CSI-RS resources. In this case, the UE 120 may identify a group identifier (and a corresponding set of CSI-RS resources) associated with a CSI report configuration. In some aspects, the UE 120 may receive information identifying scrambling codes for the CSI-RS resources. For example, the UE 120 may receive information identifying a plurality of CSI-RS resources corresponding to a plurality of different TCIs and configured with a plurality of different scrambling codes (e.g., but with the same frequency or time resources). In this case, the UE 120 may use the plurality of different scrambling codes to differentiate the plurality of different CSI-RS resources.

In some aspects, the UE 120 may derive one or more CSI-RS resources not explicitly identified with the CSI report configuration. For example, the UE 120 may receive information, associated with the CSI report configuration, identifying a particular CSI-RS resource and may identify one or more additional CSI-RS resources (e.g., to comprise the aforementioned plurality of CSI-RS resources) implicitly. In this case, the UE 120 may identify, as an implicit association, one or more additional CSI-RS resources sharing the same resource element with the identified particular CSI-RS resource (but with different scrambling sequences). In this case, the UE 120 may monitor both the particular CSI-RS resource (explicitly identified in the CSI report configuration) and the one or more additional CSI-RS resources (implicitly derived from the CSI report configuration) to determine one or more metrics to include in a CSI report.

As further shown in FIG. 10, and by reference number 1020, the UE 120 may receive a CSI-RS transmission in a plurality of CSI-RS resource. For example, the UE 120 may receive a first CSI-RS from a first port of a first TRP associated with the network node 110 and a second CSI-RS from a second port of a second TRP associated with the network node 110. As described above, in some aspects, the UE 120 may differentiate CSI-RS resources based at least in part on scrambling codes (e.g., when the CSI-RS resources share a common set of time or frequency resources).

As further shown in FIG. 10, and by reference number 1030, the UE 120 may transmit CSI reporting and/or may receive a transmission configuration. For example, the UE 120 may transmit CSI reporting to the network node 110, the network node 110 may determine a transmission configuration for communication, and/or the network node 110 may transmit information identifying the transmission configuration to the UE 120 to enable subsequent communication between the network node 110 and the UE 120, as described above.

In some aspects, the UE 120 may transmit the CSI report (e.g., the CSI report of FIGS. 9 or 10, among other examples) based at least in part on an event trigger. For example, the UE 120 may transmit the CSI report in uplink control information (UCI) (e.g., in a PUCCH or a PUSCH), but a dedicated acknowledgment resource may not be allocated for the UCI. In this case, an acknowledgment message may be conveyed from the network node 110 to the UE 120 via DCI with a sequence in a field set to indicate (e.g., via an association between the sequence and the UCI or CSI report) that the DCI is acknowledging the UCI that conveyed the CSI report. In some aspects, the sequence may be scrambled using a cyclic redundancy check (CRC). Additionally, or alternatively, the DCI may include a dedicated field that conveys an explicit identifier of the UCI or the CSI report. For example, the dedicated field may convey a CSI report identifier.

As indicated above, FIG. 10 is provided as an example. Other examples may differ from what is described with respect to FIG. 10.

FIG. 11 is a diagram illustrating an example process 1100 performed, for example, by an apparatus, in accordance with the present disclosure. Example process 1100 is an example where the UE (e.g., the UE 120) performs operations associated with using CSI-RSs for CJT in mTRP deployments.

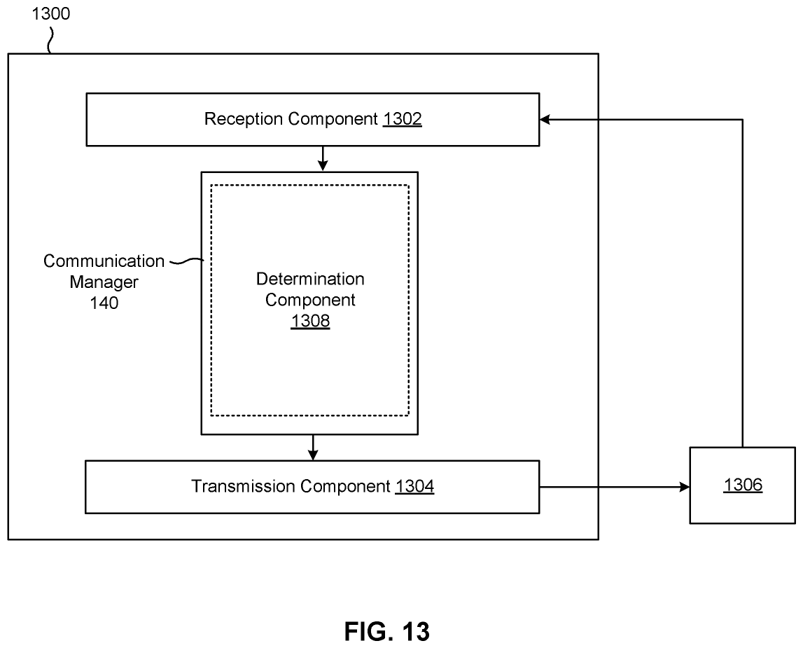

As shown in FIG. 11, in some aspects, process 1100 may include receiving, for CJT communication with a plurality of TRPs, a CSI report configuration for a CSI report associated with a plurality of TCI states, wherein the CSI report configuration indicates one or more CSI-RS resources (block 1110). For example, the apparatus (e.g., using communication manager 140 and/or reception component 1302, depicted in FIG. 13) may receive, for CJT communication with a plurality of TRPs, a CSI report configuration for a CSI report associated with a plurality of TCI states, wherein the CSI report configuration indicates one or more CSI-RS resources, as described above.

As further shown in FIG. 11, in some aspects, process 1100 may include receiving a CSI-RS transmission in the one or more CSI-RS resources using a TCI state of the plurality of TCI states (block 1120). For example, the apparatus (e.g., using communication manager 140 and/or reception component 1302, depicted in FIG. 13) may receive a CSI-RS transmission in the one or more CSI-RS resources using a TCI state of the plurality of TCI states, as described above.

Process 1100 may include additional aspects, such as any single aspect or any combination of aspects described below and/or in connection with one or more other processes described elsewhere herein.

In a first aspect, process 1100 includes transmitting the CSI report based at least in part on receiving the CSI-RS transmission.

In a second aspect, alone or in combination with the first aspect, process 1100 includes receiving a transmission configuration of a CJT communication with the plurality of TRPs, wherein the transmission configuration is based at least in part on the CSI report.

In a third aspect, alone or in combination with one or more of the first and second aspects, the one or more CSI-RS resources is a single CSI-RS resource, and the single CSI-RS resource is associated with the plurality of TCI states and the plurality of TRPs.

In a fourth aspect, alone or in combination with one or more of the first through third aspects, process 1100 includes receiving dynamic signaling activating the TCI state, and receiving the CSI-RS transmission in the one or more CSI-RS resources using the TCI state comprises receiving the CSI-RS transmission in the one or more CSI-RS resources using the TCI state based at least in part on the dynamic signaling activating the TCI state.

In a fifth aspect, alone or in combination with one or more of the first through fourth aspects, the TCI state maps to one or more ports in accordance with a TCI-state-to-port mapping for the plurality of TCI states.

In a sixth aspect, alone or in combination with one or more of the first through fifth aspects, the port is included in a port group that maps to the TCI state in accordance with the TCI-state-to-port mapping.

In a seventh aspect, alone or in combination with one or more of the first through sixth aspects, the TCI-state-to-port mapping is based at least in part on received signaling or a static rule.

In an eighth aspect, alone or in combination with one or more of the first through seventh aspects, the TCI state, corresponding to a TRP of the plurality of TRPs, is associated with a CDM group, and the CDM group does not include any other TCI states, of the plurality of TCI states, or corresponding TRPs of the plurality of TRPs, and the CDM group maps to one or more ports, wherein the one or more ports do not map to any other CDM group.

In a ninth aspect, alone or in combination with one or more of the first through eighth aspects, a time gap between signals associated with different TCI states, of the plurality of TCI states, is less than a threshold amount.

In a tenth aspect, alone or in combination with one or more of the first through ninth aspects, process 1100 includes transmitting UE feedback identifying the time gap.

In an eleventh aspect, alone or in combination with one or more of the first through tenth aspects, the CSI report configuration for CJT channel acquisition is associated with a plurality of CSI-RS resources for channel measurements, and each CSI-RS resource, of the plurality of CSI-RS resources, is associated with a corresponding TCI state, of the plurality of TCI states, and a corresponding TRP of the plurality of TRPs.

In a twelfth aspect, alone or in combination with one or more of the first through eleventh aspects, the plurality of CSI-RS resources are for channel measurement.

In a thirteenth aspect, alone or in combination with one or more of the first through twelfth aspects, the CSI report configuration is associated with reporting of at least one of a precoding matrix indicator, a rank indicator, or a channel quality indicator.

In a fourteenth aspect, alone or in combination with one or more of the first through thirteenth aspects, the plurality of CSI-RS resources are linked based at least in part on a group identifier.

In a fifteenth aspect, alone or in combination with one or more of the first through fourteenth aspects, process 1100 includes determining a metric for CJT across the plurality of TRPs based at least in part on the plurality of CSI-RS resources, wherein the metric is at least one of a precoding matrix indicator, a rank indicator, or a channel quality indicator.

In a sixteenth aspect, alone or in combination with one or more of the first through fifteenth aspects, the plurality of CSI-RS resources are associated with a plurality of scrambling codes, and the plurality of CSI-RS resources are associated with a common set of frequency resources or time resources.

In a seventeenth aspect, alone or in combination with one or more of the first through sixteenth aspects, the plurality of CSI-RS resources are associated with the CSI report configuration based at least in part on an implicit association rule.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with using CSI-RSs for CJT in mTRP deployments.

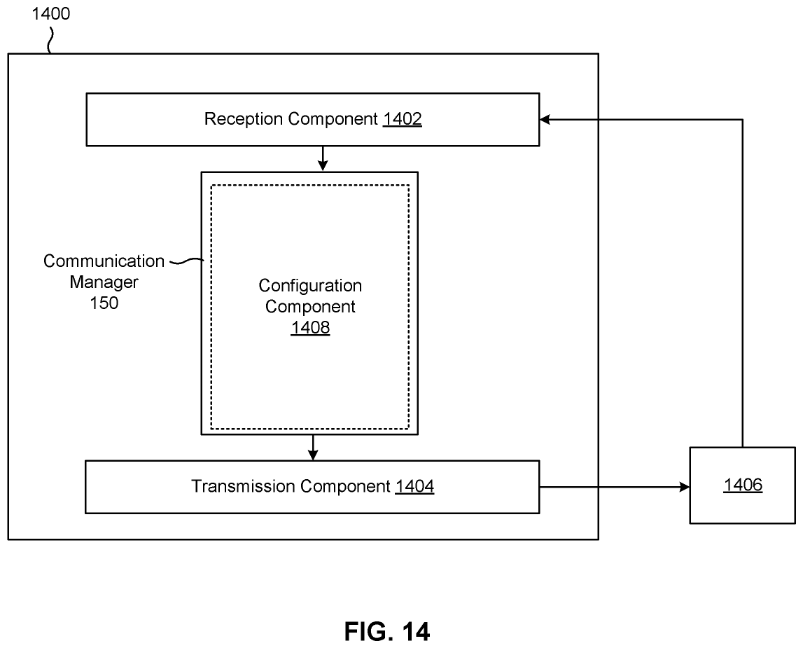

As shown in FIG. 12, in some aspects, process 1200 may include transmitting, for CJT communication with a plurality of TRPs, a CSI report configuration for a CSI report associated with a plurality of TCI states, wherein the CSI report configuration indicates one or more CSI-RS resources (block 1210). For example, the network node (e.g., using communication manager 150 and/or transmission component 1404, depicted in FIG. 14) may transmit, for CT communication with a plurality of TRPs, a CSI report configuration for a CSI report associated with a plurality of TCI states, wherein the CSI report configuration indicates one or more CSI-RS resources, as described above.

As further shown in FIG. 12, in some aspects, process 1200 may include transmitting a CSI-RS transmission in the one or more CSI-RS resources using a TCI state of the plurality of TCI states (block 1220). For example, the network node (e.g., using communication manager 150 and/or transmission component 1404, depicted in FIG. 14) may transmit a CSI-RS transmission in the one or more CSI-RS resources using a TCI state of the plurality of TCI states, as described above.

Process 1200 may include additional aspects, such as any single aspect or any combination of aspects described below and/or in connection with one or more other processes described elsewhere herein.

In a first aspect, process 1200 includes receiving the CSI report based at least in part on receiving the CSI-RS transmission.

In a second aspect, alone or in combination with the first aspect, process 1200 includes transmitting a transmission configuration of a CJT communication with the plurality of TRPs, wherein the transmission configuration is based at least in part on the CSI report.

In a third aspect, alone or in combination with one or more of the first and second aspects, the one or more CSI-RS resources is a single CSI-RS resource, and the single CSI-RS resource is associated with the plurality of TCI states and the plurality of TRPs.

In a fourth aspect, alone or in combination with one or more of the first through third aspects, process 1200 includes transmitting dynamic signaling activating the TCI state, and transmitting the CSI-RS transmission in the one or more CSI-RS resources using the TCI state comprises transmitting the CSI-RS transmission in the one or more CSI-RS resources using the TCI state based at least in part on the dynamic signaling activating the TCI state.

In a fifth aspect, alone or in combination with one or more of the first through fourth aspects, the TCI state maps to one or more ports in accordance with a TCI-state-to-port mapping for the plurality of TCI states.

In a sixth aspect, alone or in combination with one or more of the first through fifth aspects, the port is included in a port group that maps to the TCI state in accordance with the TCI-state-to-port mapping.

In a seventh aspect, alone or in combination with one or more of the first through sixth aspects, the TCI-state-to-port mapping is based at least in part on received signaling or a static rule.

In an eighth aspect, alone or in combination with one or more of the first through seventh aspects, the TCI state, corresponding to a TRP of the plurality of TRPs, is associated with a CDM group, and the CDM group does not include any other TCI states, of the plurality of TCI states, or corresponding TRPs of the plurality of TRPs, and the CDM group maps to one or more ports, wherein the one or more ports do not map to any other CDM group.

In a ninth aspect, alone or in combination with one or more of the first through eighth aspects, a time gap between signals associated with different TCI states, of the plurality of TCI states, is less than a threshold amount.

In a tenth aspect, alone or in combination with one or more of the first through ninth aspects, process 1200 includes receiving feedback information identifying the time gap.

In an eleventh aspect, alone or in combination with one or more of the first through tenth aspects, the CSI report configuration for CJT channel acquisition is associated with a plurality of CSI-RS resources for channel measurements, and each CSI-RS resource, of the plurality of CSI-RS resources, is associated with a corresponding TCI state, of the plurality of TCI states, and a corresponding TRP of the plurality of TRPs.

In a twelfth aspect, alone or in combination with one or more of the first through eleventh aspects, the plurality of CSI-RS resources are for channel measurement.

In a thirteenth aspect, alone or in combination with one or more of the first through twelfth aspects, the CSI report configuration is associated with reporting of at least one of a precoding matrix indicator, a rank indicator, or a channel quality indicator.

In a fourteenth aspect, alone or in combination with one or more of the first through thirteenth aspects, the plurality of CSI-RS resources are linked based at least in part on a group identifier.

In a fifteenth aspect, alone or in combination with one or more of the first through fourteenth aspects, process 1200 includes receiving information identifying a metric for CJT across the plurality of TRPs based at least in part on the plurality of CSI-RS resources, wherein the metric is at least one of a precoding matrix indicator, a rank indicator, or a channel quality indicator.

In a sixteenth aspect, alone or in combination with one or more of the first through fifteenth aspects, the plurality of CSI-RS resources are associated with a plurality of scrambling codes, and the plurality of CSI-RS resources are associated with a common set of frequency resources or time resources.

In a seventeenth aspect, alone or in combination with one or more of the first through sixteenth aspects, the plurality of CSI-RS resources are associated with the CSI report configuration based at least in part on an implicit association rule.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include a determination component 1308, among other examples.

In some aspects, the apparatus 1300 may be configured to perform one or more operations described herein in connection with FIGS. 9-10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive, for CJT communication with a plurality of TRPs, a CSI report configuration for a CSI report associated with a plurality of TCI states, wherein the CSI report configuration indicates one or more CSI-RS resources. The reception component 1302 may receive a CSI-RS transmission in the one or more CSI-RS resources using a TCI state of the plurality of TCI states.

The transmission component 1304 may transmit the CSI report based at least in part on receiving the CSI-RS transmission. The reception component 1302 may receive a transmission configuration of a CJT communication with the plurality of TRPs, wherein the transmission configuration is based at least in part on the CSI report. The reception component 1302 may receive dynamic signaling activating the TCI state. The transmission component 1304 may transmit UE feedback identifying the time gap. The determination component 1308 may determine a metric for CJT across the plurality of TRPs based at least in part on the plurality of CSI-RS resources.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include a configuration component 1408, among other examples.

In some aspects, the apparatus 1400 may be configured to perform one or more operations described herein in connection with FIGS. 9-10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The transmission component 1404 may transmit, for CJT communication with a plurality of TRPs, a CSI report configuration for a CSI report associated with a plurality of TCI states, wherein the CSI report configuration indicates one or more CSI-RS resources. The transmission component 1404 may transmit a CSI-RS transmission in the one or more CSI-RS resources using a TCI state of the plurality of TCI states.

The reception component 1402 may receive the CSI report based at least in part on receiving the CSI-RS transmission. The transmission component 1404 may transmit a transmission configuration of a CJT communication with the plurality of TRPs, wherein the transmission configuration is based at least in part on the CSI report. The transmission component 1404 may transmit dynamic signaling activating the TCI state. The reception component 1402 may receive feedback information identifying the time gap. The reception component 1402 may receive information identifying a metric for CJT across the plurality of TRPs based at least in part on the plurality of CSI-RS resources. The configuration component 1408 may configure a CSI report configuration and/or an associated set of CSI-RSs and CSI-RS resources for a set of TRPs.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by an apparatus of a user equipment (UE), comprising: receiving, for coherent joint transmission (CJT) communication with a plurality of transmit receive points (TRPs), a channel state information (CSI) report configuration for a CSI report associated with a plurality of transmission configuration indicator (TCI) states, wherein the CSI report configuration indicates one or more CSI reference signal (CSI-RS) resources; and receiving a CSI-RS transmission in the one or more CSI-RS resources using a TCI state of the plurality of TCI states.

Aspect 2: The method of Aspect 1, further comprising: transmitting the CSI report based at least in part on receiving the CSI-RS transmission.

Aspect 3: The method of Aspect 2, further comprising: receiving a transmission configuration of a CJT communication with the plurality of TRPs, wherein the transmission configuration is based at least in part on the CSI report.

Aspect 4: The method of any of Aspects 1 to 3, wherein the one or more CSI-RS resources is a single CSI-RS resource, and wherein the single CSI-RS resource is associated with the plurality of TCI states and the plurality of TRPs.

Aspect 5: The method of any of Aspects 1 to 4, further comprising: receiving dynamic signaling activating the TCI state; and wherein receiving the CSI-RS transmission in the one or more CSI-RS resources using the TCI state comprises: receiving the CSI-RS transmission in the one or more CSI-RS resources using the TCI state based at least in part on the dynamic signaling activating the TCI state.

Aspect 6: The method of any of Aspects 1 to 5, wherein the TCI state maps to one or more ports in accordance with a TCI-state-to-port mapping for the plurality of TCI states.

Aspect 7: The method of Aspect 6, wherein the port is included in a port group that maps to the TCI state in accordance with the TCI-state-to-port mapping.

Aspect 8: The method of any of Aspects 6 to 7, wherein the TCI-state-to-port mapping is based at least in part on received signaling or a static rule.

Aspect 9: The method of any of Aspects 1 to 8, wherein the TCI state, corresponding to a TRP of the plurality of TRPs, is associated with a code division multiplexing (CDM) group, and wherein the CDM group does not include any other TCI states, of the plurality of TCI states, or corresponding TRPs of the plurality of TRPs, and wherein the CDM group maps to one or more ports, wherein the one or more ports do not map to any other CDM group.

Aspect 10: The method of any of Aspects 1 to 9, wherein a time gap between signals associated with different TCI states, of the plurality of TCI states, is less than a threshold amount.

Aspect 11: The method of Aspect 10, further comprising: transmitting UE feedback identifying the time gap.

Aspect 12: The method of any of Aspects 1 to 10, wherein the CSI report configuration for CJT channel acquisition is associated with a plurality of CSI-RS resources for channel measurements, and wherein each CSI-RS resource, of the plurality of CSI-RS resources, is associated with a corresponding TCI state, of the plurality of TCI states, and a corresponding TRP of the plurality of TRPs.

Aspect 13: The method of Aspect 12, wherein the plurality of CSI-RS resources are for channel measurement.

Aspect 14: The method of any of Aspects 12 to 13, wherein the CSI report configuration is associated with reporting of at least one of: a precoding matrix indicator, a rank indicator, or a channel quality indicator.

Aspect 15: The method of any of Aspects 12 to 14, wherein the plurality of CSI-RS resources are linked based at least in part on a group identifier.

Aspect 16: The method of any of Aspects 12 to 15, further comprising: determining a metric for CJT across the plurality of TRPs based at least in part on the plurality of CSI-RS resources, wherein the metric is at least one of: a precoding matrix indicator, a rank indicator, or a channel quality indicator.

Aspect 17: The method of any of Aspects 12 to 16, wherein the plurality of CSI-RS resources are associated with a plurality of scrambling codes, and wherein the plurality of CSI-RS resources are associated with a common set of frequency resources or time resources.

Aspect 18: The method of any of Aspects 12 to 17, wherein the plurality of CSI-RS resources are associated with the CSI report configuration based at least in part on an implicit association rule.

Aspect 19: A method of wireless communication performed by a network node, comprising: transmitting, for coherent joint transmission (CT) communication with a plurality of transmit receive points (TRPs), a channel state information (CSI) report configuration for a CSI report associated with a plurality of transmission configuration indicator (TCI) states, wherein the CSI report configuration indicates one or more CSI reference signal (CSI-RS) resources; and transmitting a CSI-RS transmission in the one or more CSI-RS resources using a TCI state of the plurality of TCI states.

Aspect 20: The method of Aspect 19, further comprising: receiving the CSI report based at least in part on receiving the CSI-RS transmission.

Aspect 21: The method of Aspect 20, further comprising: transmitting a transmission configuration of a CT communication with the plurality of TRPs, wherein the transmission configuration is based at least in part on the CSI report.

Aspect 22: The method of any of Aspects 19 to 21, wherein the one or more CSI-RS resources is a single CSI-RS resource, and wherein the single CSI-RS resource is associated with the plurality of TCI states and the plurality of TRPs.

Aspect 23: The method of any of Aspects 19 to 22, further comprising: transmitting dynamic signaling activating the TCI state; and wherein transmitting the CSI-RS transmission in the one or more CSI-RS resources using the TCI state comprises: transmitting the CSI-RS transmission in the one or more CSI-RS resources using the TCI state based at least in part on the dynamic signaling activating the TCI state.

Aspect 24: The method of any of Aspects 19 to 23, wherein the TCI state maps to one or more ports in accordance with a TCI-state-to-port mapping for the plurality of TCI states.

Aspect 25: The method of Aspect 24, wherein the port is included in a port group that maps to the TCI state in accordance with the TCI-state-to-port mapping.

Aspect 26: The method of any of Aspects 24 to 25, wherein the TCI-state-to-port mapping is based at least in part on received signaling or a static rule.

Aspect 27: The method of any of Aspects 19 to 26, wherein the TCI state, corresponding to a TRP of the plurality of TRPs, is associated with a code division multiplexing (CDM) group, and wherein the CDM group does not include any other TCI states, of the plurality of TCI states, or corresponding TRPs of the plurality of TRPs, and wherein the CDM group maps to one or more ports, wherein the one or more ports do not map to any other CDM group.

Aspect 28: The method of any of Aspects 19 to 27, wherein a time gap between signals associated with different TCI states, of the plurality of TCI states, is less than a threshold amount.

Aspect 29: The method of Aspect 28, further comprising: receiving feedback information identifying the time gap.

Aspect 30: The method of any of Aspects 19 to 29, wherein the CSI report configuration for CJT channel acquisition is associated with a plurality of CSI-RS resources for channel measurements, and wherein each CSI-RS resource, of the plurality of CSI-RS resources, is associated with a corresponding TCI state, of the plurality of TCI states, and a corresponding TRP of the plurality of TRPs.

Aspect 31: The method of Aspect 30, wherein the plurality of CSI-RS resources are for channel measurement.

Aspect 32: The method of any of Aspects 30 to 31, wherein the CSI report configuration is associated with reporting of at least one of: a precoding matrix indicator, a rank indicator, or a channel quality indicator.

Aspect 33: The method of any of Aspects 30 to 32, wherein the plurality of CSI-RS resources are linked based at least in part on a group identifier.

Aspect 34: The method of any of Aspects 30 to 33, further comprising: receiving information identifying a metric for CJT across the plurality of TRPs based at least in part on the plurality of CSI-RS resources, wherein the metric is at least one of: a precoding matrix indicator, a rank indicator, or a channel quality indicator.

Aspect 35: The method of any of Aspects 30 to 34, wherein the plurality of CSI-RS resources are associated with a plurality of scrambling codes, and wherein the plurality of CSI-RS resources are associated with a common set of frequency resources or time resources.

Aspect 36: The method of any of Aspects 30 to 35, wherein the plurality of CSI-RS resources are associated with the CSI report configuration based at least in part on an implicit association rule.

Aspect 37: An apparatus for wireless communication at a device, comprising a processor, memory coupled with the processor, and instructions stored in the memory and executable by the processor to cause the apparatus to perform the method of one or more of Aspects 1-18.

Aspect 38: A device for wireless communication, comprising a memory and one or more processors coupled to the memory, the one or more processors configured to perform the method of one or more of Aspects 1-18.

Aspect 39: An apparatus for wireless communication, comprising at least one means for performing the method of one or more of Aspects 1-18.

Aspect 40: A non-transitory computer-readable medium storing code for wireless communication, the code comprising instructions executable by a processor to perform the method of one or more of Aspects 1-18.

Aspect 41: A non-transitory computer-readable medium storing a set of instructions for wireless communication, the set of instructions comprising one or more instructions that, when executed by one or more processors of a device, cause the device to perform the method of one or more of Aspects 1-18.

Aspect 42: An apparatus for wireless communication at a device, comprising a processor, memory coupled with the processor, and instructions stored in the memory and executable by the processor to cause the apparatus to perform the method of one or more of Aspects 19-36.

Aspect 43: A device for wireless communication, comprising a memory and one or more processors coupled to the memory, the one or more processors configured to perform the method of one or more of Aspects 19-36.

Aspect 44: An apparatus for wireless communication, comprising at least one means for performing the method of one or more of Aspects 19-36.

Aspect 45: A non-transitory computer-readable medium storing code for wireless communication, the code comprising instructions executable by a processor to perform the method of one or more of Aspects 19-36.

Aspect 46: A non-transitory computer-readable medium storing a set of instructions for wireless communication, the set of instructions comprising one or more instructions that, when executed by one or more processors of a device, cause the device to perform the method of one or more of Aspects 19-36.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, for coherent joint transmission (CJT) communication with a plurality of transmit receive points (TRPs), a channel state information (CSI) report configuration for a CSI report associated with a plurality of transmission configuration indicator (TCI) states, wherein the CSI report configuration indicates one or more CSI reference signal (CSI-RS) resources; and
receive a CSI-RS transmission in the one or more CSI-RS resources using a TCI state of the plurality of TCI states.

2. The UE of claim 1, wherein the one or more processors are further configured to:
transmit the CSI report based at least in part on receiving the CSI-RS transmission.

3. The UE of claim 2, wherein the one or more processors are further configured to:
receive a transmission configuration of a CJT communication with the plurality of TRPs, wherein the transmission configuration is based at least in part on the CSI report.

4. The UE of claim 1, wherein the one or more CSI-RS resources is a single CSI-RS resource, and
wherein the single CSI-RS resource is associated with the plurality of TCI states and the plurality of TRPs.

5. The UE of claim 1, wherein the one or more processors are further configured to:
receive dynamic signaling activating the TCI state; and
wherein the one or more processors, to receive the CSI-RS transmission in the one or more CSI-RS resources using the TCI state, are configured to:
receive the CSI-RS transmission in the one or more CSI-RS resources using the TCI state based at least in part on the dynamic signaling activating the TCI state.

6. The UE of claim 1, wherein the TCI state maps to one or more ports in accordance with a TCI-state-to-port mapping for the plurality of TCI states.

7. The UE of claim 6, wherein the port is included in a port group that maps to the TCI state in accordance with the TCI-state-to-port mapping.

8. The UE of claim 6, wherein the TCI-state-to-port mapping is based at least in part on received signaling or a static rule.

9. The UE of claim 1, wherein the TCI state, corresponding to a TRP of the plurality of TRPs, is associated with a code division multiplexing (CDM) group, and wherein the CDM group does not include any other TCI states, of the plurality of TCI states, or corresponding TRPs of the plurality of TRPs, and
wherein the CDM group maps to one or more ports, wherein the one or more ports do not map to any other CDM group.

10. The UE of claim 1, wherein a time gap between signals associated with different TCI states, of the plurality of TCI states, is less than a threshold amount.

11. The UE of claim 10, wherein the one or more processors are further configured to:
transmit UE feedback identifying the time gap.

12. The UE of claim 1, wherein the CSI report configuration for CJT channel acquisition is associated with a plurality of CSI-RS resources for channel measurements, and
wherein each CSI-RS resource, of the plurality of CSI-RS resources, is associated with a corresponding TCI state, of the plurality of TCI states, and a corresponding TRP of the plurality of TRPs.

13. The UE of claim 12, wherein the plurality of CSI-RS resources are for channel measurement.

14. The UE of claim 12, wherein the CSI report configuration is associated with reporting of at least one of:
a precoding matrix indicator,
a rank indicator, or
a channel quality indicator.

15. The UE of claim 12, wherein the plurality of CSI-RS resources are linked based at least in part on a group identifier.

16. The UE of claim 12, wherein the one or more processors are further configured to:
determine a metric for CJT across the plurality of TRPs based at least in part on the plurality of CSI-RS resources,
wherein the metric is at least one of:
a precoding matrix indicator,
a rank indicator, or
a channel quality indicator.

17. The UE of claim 12, wherein the plurality of CSI-RS resources are associated with a plurality of scrambling codes, and
wherein the plurality of CSI-RS resources are associated with a common set of frequency resources or time resources.

18. The UE of claim 12, wherein the plurality of CSI-RS resources are associated with the CSI report configuration based at least in part on an implicit association rule.

19. A network node for wireless communication, comprising:
a memory; and
one or more processors, coupled to the memory, configured to:
transmit, for coherent joint transmission (CJT) communication with a plurality of transmit receive points (TRPs), a channel state information (CSI) report configuration for a CSI report associated with a plurality of transmission configuration indicator (TCI) states, wherein the CSI report configuration indicates one or more CSI reference signal (CSI-RS) resources; and
transmit a CSI-RS transmission in the one or more CSI-RS resources using a TCI state of the plurality of TCI states.

20. The network node of claim 19, wherein the one or more processors are further configured to:
receive the CSI report based at least in part on receiving the CSI-RS transmission.

21. The network node of claim 20, wherein the one or more processors are further configured to:
transmit a transmission configuration of a CT communication with the plurality of TRPs, wherein the transmission configuration is based at least in part on the CSI report.

22. The network node of claim 19, wherein the one or more CSI-RS resources is a single CSI-RS resource, and
wherein the single CSI-RS resource is associated with the plurality of TCI states and the plurality of TRPs.

23. The network node of claim 19, wherein the one or more processors are further configured to:
transmit dynamic signaling activating the TCI state; and
wherein the one or more processors, to transmit the CSI-RS transmission in the one or more CSI-RS resources using the TCI state, are configured to:
transmit the CSI-RS transmission in the one or more CSI-RS resources using the TCI state based at least in part on the dynamic signaling activating the TCI state.

24. The network node of claim 19, wherein the TCI state maps to one or more ports in accordance with a TCI-state-to-port mapping for the plurality of TCI states.

25. The network node of claim 24, wherein the port is included in a port group that maps to the TCI state in accordance with the TCI-state-to-port mapping.

26. The network node of claim 24, wherein the TCI-state-to-port mapping is based at least in part on received signaling or a static rule.

27. The network node of claim 19, wherein the TCI state, corresponding to a TRP of the plurality of TRPs, is associated with a code division multiplexing (CDM) group, and wherein the CDM group does not include any other TCI states, of the plurality of TCI states, or corresponding TRPs of the plurality of TRPs, and
wherein the CDM group maps to one or more ports, wherein the one or more ports do not map to any other CDM group.

28. The network node of claim 19, wherein a time gap between signals associated with different TCI states, of the plurality of TCI states, is less than a threshold amount.

29. A method of wireless communication performed by an apparatus of a user equipment (UE), comprising:
receiving, for coherent joint transmission (CT communication with a plurality of transmit receive points (TRPs), a channel state information (CSI) report configuration for a CSI report associated with a plurality of transmission configuration indicator (TCI) states, wherein the CSI report configuration indicates one or more CSI reference signal (CSI-RS) resources; and
receiving a CSI-RS transmission in the one or more CSI-RS resources using a TCI state of the plurality of TCI states.

30. A method of wireless communication performed by a network node, comprising:
transmitting, for coherent joint transmission (CJT) communication with a plurality of transmit receive points (TRPs), a channel state information (CSI) report configuration for a CSI report associated with a plurality of transmission configuration indicator (TCI) states, wherein the CSI report configuration indicates one or more CSI reference signal (CSI-RS) resources; and
transmitting a CSI-RS transmission in the one or more CSI-RS resources using a TCI state of the plurality of TCI states.
